(19) United States
(12) Patent Application Publication
(10) Pub. No.: US 2017/0337768 A1
(43) Pub. Date: Nov. 23, 2017

(54) METHOD AND A SYSTEM FOR EXCHANGING OBJECTS BETWEEN REAL AND VIRTUAL ENVIRONMENTS

(71) Applicants: Elias Shamilov, Eshchar (IL); Eran Horesh, Eshchar (IL)

(72) Inventor: Elias Shamilov, Eshchar (IL)

(21) Appl. No.: 15/522,380

(22) PCT Filed: Oct. 26, 2015
(86) PCT No.: PCT/IL15/51047

§ 371 Date: Apr. 27, 2017

Related U.S. Application Data
(60) Provisional application No. 62/068,781, filed on Oct. 27, 2014.

(51) Int. Cl. G07F 17/32; A63F 13/69; A63F 13/98; A63F 13/24

(52) U.S. Cl. CPC G07F 17/3227; G07F 17/326; A63F 13/24; A63F 13/69; A63F 13/98

(57) ABSTRACT

A system and a method for converting items from virtual environment to real environment and vice versa is disclosed. A computing and a converting device is used, the converter is capable to receive and to identify an identify-able item, store the item inside and affect the display to add an image of the item to the displayed image. In vice versa, an item can disappears from the image—from any software or user condition—and the software affects the converter to provide a real item.

### BACKGROUND

The present invention generally relates to video games, and more particularly to a video game and a peripheral for a video game.

A video game is an electronic game that involves human interaction with a user interface to generate visual feedback on a video display. The word video refers to any type of display device that can produce two, or three, dimensional images. Those devices draw some virtual environment—drawn (virtual) objects in a drawn (virtual) world (may be drawn in two, or three dimensions). The electronic systems used to play video games are known as platforms. Examples of platforms are personal computers and video game consoles. It is noted that “drawn” is referred herein to “drawn on the screen”—it can be illustrated, photographed or filmed or any combination thereof. I.e., a TV-show or holographic image are also drawn.

Various video games use virtual items that exist in a digital environment. Those item usually have some function in a game. For example, coins or mushrooms in the well-known Super Mario game.

Most video games are video only, i.e. one only needs a platform and display in order to play it. Some games use peripheral devices for games, for example a steering wheel for race games. Some games use a virtual mapping of a real item: the virtual copy of a real item shown by a display. In order to use a virtual pare of a real item a player can be asked to enter a code of a real item to the game (i.e., webkinz), or to put the real item on some device, or just to buy the real item in order the virtual mapping will appear.

The present invention is a method and a system for exchanging objects between real and virtual environments. The features of the present invention are—inter alia—a real component is exist, a virtual component is exist, the real component can appear or disappear and the virtual component can appear or disappear.

There are some publications that disclose partly similar systems or methods, each one of these systems or methods lacks one or more of the mentioned features. Moreover, all of these systems or methods lack the capability of disappearing the real item.

The mentioned publications are:

US application 20110098092 of Reiche et al “VIDEO GAME WITH REPRESENTATIVE PHYSICAL OBJECT RELATED CONTENT”.

US application 20100005007 of Cox et al “METHODS OF ASSOCIATING REAL WORLD ITEMS WITH VIRTUAL WORLD REPRESENTATIONS”

U.S. Pat. No. 8,475,275 to Weston et al “Interactive toys and games connecting physical and virtual play environments”

U.S. Pat. No. 8,272,945 to Kelly et al “Game related systems, methods, and articles that combine virtual and physical elements”

U.S. Pat. No. 8,556,719 to Mahajan et al “Linking virtual items to real-world items”

U.S. Pat. No. 6,290,565 to Galyena et al “Interactive game apparatus with game play controlled by user-modifiable toy”

U.S. Pat. No. 8,738,533 to Hill el al “Real-world items unlocking virtual items online and in video games”

US application 20070211047 of Dona et al “Persistent authenticating system and method to map real world object presence into virtual world object awareness”

US application 20050288078 of Cheok et al “Game”

U.S. Pat. No. 6,229,533 to Farmer et al “Ghost object for a virtual world”

U.S. Pat. No. 8,639,588 to Finn et al “Externalizing virtual object tags relating to virtual objects”

Therefore, the advantage of the present invention is that it includes all the mentioned features, while the others lack some of these features and all of then lack the feature of disappearing the real item when it is converted to virtual.

### SUMMARY OF THE INVENTION

The present invention is a method and a system for exchanging objects between real and virtual environments.

The system of the present invention may comprise any combination of display, device and a computer. Such system may comprise tablets, smartphones, laptops, PCs, television, smart televisions. The system may also be provided as one part (“all in one”). The device may be integrated with the display or the computer.

The system, according to one embodiment of the present invention, comprised of computing device with a display running dedicated software or algorithm (hearing after “display”) and a converting device (hearing after “converter”) connected to the computing device. The display can be embedded in the converter or only a display while the computing unit is embedded in the converter.

The converter, having an inlet and an outlet, capable to receive through its inlet and to identify an identify-able item, and preferably store the item inside and affect the display to add an image of the item onto the displayed image. By this way, the item disappears from the real world and appears in the virtual world. In vice versa, an item can disappears from the image—from any software or user condition—and the software affects the converter to provide a real item, same as the disappeared item, from its storage through its outlet. By this way, the item disappears from the virtual world and appears in the real world. In alternative option, wherein the item is not stored it is destroyed as described.

Obviously, if the converter cannot receive the item from any reason—cannot identify the item, the store is full or any other reason—it provides it back via its outlet and if the item cannot be provided from any reason, the item does not disappears from the image.

Those real items and virtual items are a pair where only one of them can exist at the same moment in either environment (real or virtual). Both real items and virtual items can be created as mapping of their pair (when its pair disappears) or can be created independently (found, bought, earned etc.). The real items and virtual items are not always a pair, since there is a possibility that an item—real or virtual is divided to several users. Both real items and virtual items can be destroyed by moving to the complementary instantiation (real to virtual or virtual to real, then its pair appears) or can be destroyed independently (lost, sold, broken, eaten, etc.). Creation of a real item can be done by ejecting of a pre fab item outside the converter, or by creating the item from its ingredients or using standard existing objects fulfilling specific criterion, such as balls, coins, Lego bricks, cubes. As well the destruction of real item can be done by shredding or other type annihilation, or by dismantling to ingredients, or by just hiding the real item from the user's eyes. Creation and destruction of virtual items can be done by drawing and by erasing the item from the display (2D or 3D) or by increasing or decreasing the same counter of those items.

When a real item is inserted into the converter (i.e., into the game), it is identified by it. This identification can be achieved, via item types (size, view, etc.), unique ID's or any other identification method. The converter checks whether the item is acceptable at the present time. The list of possible types and ID's can be saved locally on the converter, locally on the connected computer or in some remote server or cloud. If the item is accepted, then the appropriate message is send to the software, and the paired virtual item appears on the display and the real item is not ejected from the converter. Inside the converter the real item can be saved, or can be disassembled or even destroyed. If the real item is saved, it can be sorted to the corresponding stack of real items (real stack). The sorting can be done by item's size, by item's form or by some authentication method (RFID, barcode, etc.). The store of real stacks can be internal or external of the converter. External stacks can be replaced by the used to other stacks. External stack can be also identified by the converter, such that the converter will “know” in which stack to store each item. The stacks can also be identified by type or by unique ID. An example for such stack is a coin tube for coins-storage, as used in coin chargers.

When software needs to move a virtual item to the real world (by user's request or because of any other reason) it checks with a converter, whether the paired real item can be ejected now. If yes, the software erases the virtual item from the display and sends the ejection command to the converter. The converter can create a new real item or eject one from a corresponding stack. In case the converter ejects a real item, it can mention it as realized in its database (local or remote).

The real items can be identified by their form or by digital ID, or by RF ID or by any other identification method. They can belong to several types and be defined by their type, when there is no difference between one item of some type to another one (like coins in the real life, there is no difference between one cent to another. Special edition coins are out of this scope). There is an option to add items like quarter's wherein this items are different one from another by view, but there outer line and physical dimension are the same. Another option is item differentiation: the real items not only belong to some type, but each real item has also its own ID. But this ID does not affect for item's role. I.e. different items from one type have the same properties (except for IDs, like banknotes, that have their serial number). In this case, there can be an option to mark items as “active” or “inactive”. An “active” item is an item that was ejected by the converter. Such “active” item can be accepted by a converter and “moved” to virtual world. When an item is accepted by the converter, it marked as “inactive”, and if it was not ejected, but somehow wanted to be inserted again—it will not be accepted, because it's in active. The mark should be visible, for example different colors. In this case, the active and inactive items' database can be shared via local network or the internet. According to the present invention, it can be provides a system that includes the converter that is described above that works with aggregated items. I.e. one real item can describe a group of virtual items (and vice versa). For example, the virtual item can be a coin; the real items can be coins of 1, 2, 5 and 10. And in vice versa.

In a preferred embodiment, according to the present invention, it is provided a system for converting items from virtual environment to real environment and vice versa. This system is comprised of (a) a converting device having an inlet, an outlet, an identifying capability and a communication capability, wherein communication ability may also be mechanical (such physical element activating others), and while inserting an identified-able item—through the inlet—the converter identified the item and use the communication capability to affect a computing system to add an image of the item to a running software's image, the converter is capable to provide an item through the outlet according to the computing system command, same of the item that its image was removed from the running software's image; and (b) a computing system with display—running a software that usually is a game—wherein the software capable to add to the item's image—virtual same item of the inserted real item according to the converter's message or to delete a virtual item from running software's image and to affect the converter to provide same real item through its outlet.

According to another preferred embodiment, the system is provided wherein the converting device is comprised of (a) an inlet enables to inset at least one item to the converter; (b) an identifier for identifying, the inserted item, and to receive back unidentified items; (c) an item's store capable to store the inserted items, wherein the items are sorted according to a predetermined criteria; (d) a receiver capable to receive items from the store, according to a command; and (e) an outlet enables the received items to get out.

According to another preferred embodiment, the system is provided wherein the item's store is located outside of the converting device.

According to another preferred embodiment, the system further includes a sorter and at least two item's stores and wherein the sorter sorts the inserted items to one of the item's stores according to predetermined criteria. Moreover, the system can further includes a marker for marking items as active or inactive.

According to another preferred embodiment, the system further includes at least two receivers, a receiver for each item's store, enables to receive items each item's store through a dedicated receiver.

According to another preferred embodiment, the system is provided wherein the converting device is comprised of (a) an inlet enables to inset item to the converter; (b) an identifier for identifying, the inserted item, and to receive back unidentified items; (c) a item's destructor for destructing the inserted items; (d) an item's creator for creating item according to a command; (e) a receiver capable to receive out the created items; and (f) an outlet enables the received items to get out.

According to another preferred embodiment, the system further includes a fillable ingredients' storage and cleanable waste box or recycle for another use, in respect of the present invention.

According to another preferred embodiment, the system is provided wherein the item is identified by his shape, by digital ID or any other identification method.

According to another preferred embodiment, the system is provided wherein the items are coins and the converter can be or includes a coin dispenser.

According to another preferred embodiment, the system is provided wherein the converter includes a 3D printer and shredder, for destroying 3D items.

According to another preferred embodiment, the system is provided wherein the converter includes a managing software, wherein the software can includes games or may connect to third party game or tutorials, wherein real item is inserted into the converter, identified by the converter, and the converter notifies the game that a new item was added and wherein the inserted item can be moved to the virtual or ejected back to the real and when the real item disappears, it can be destroyed by the converter or saved inside thereof.

According to another preferred embodiment, the system is provided wherein the item is made of a plurality of units—e.g., coins—and the system can count or evaluate the units and use the item regarding the number or value of the units.

According to another preferred embodiment, the system includes at least two computers that are connected among them and each one of them is connected to such converter. In this case it's possible to use the system for real item's “teleportation”—an item is inserted into one device that is connected to some computer and is ejected from another device that is connected to another computer. In this case the drawing of the device can appear in the middle of the process on some of the displays, on both displays or on no one of the displays.

According to another aspect of the present invention, it is provided a method for exchanging items from virtual environment to real environment and vice versa, this method comprised of the following steps: (a) using a converting device with identification and communication ability and the ability to get inside identified-able items and get out identified-able items; (b) connecting the converter to a computing system that capable to display a software image—usually a game software; (c) while an item is inserted to the converter, it is identified and a virtual image of the item is added to the displayed image; (d) if the item cannot be identified, the converter gives the item back; (e) while the software removes a virtual item from the display, the software commands the converter to get out a real item same of the removed item; and (f) if the converter cannot recognize the command, the user is received a notice.

The provided method is also provided wherein the used converting device performs the following steps: (a) receiving an inserted item; (b) identifying, the inserted item, and receiving back unidentified items; (c) sorting and storing the inserted items in an item's store or stores, wherein the items are sorted according to a predetermined criteria; (d) a receiver capable to receive items from the store, according to a command; and (e) providing an item, a created item or from the item's store, according to command.

### BRIEF DESCRIPTION OF THE DRAWINGS

Exemplary and/or illustrative embodiments of the present invention will be presented herein below in the following figures, by way of example only. The figures are not necessarily to scale, and some features may be exaggerated or minimized and/or roughly shown and/or omitted entirely, to show details of particular components, intending that the present invention may become more fully understood from the detailed description and the accompanying schematic figures, wherein:

FIG. 01 illustrates the system overview.

FIG. 02 illustrates the virtualization flow.

FIG. 03 illustrates the realization flow.

FIG. 04 illustrates realization flow chart.

FIG. 05 illustrates virtualization flow chart.

FIG. 06 illustrates realization flow chart with unique items.

FIG. 07 illustrates virtualization flow chart with unique items

FIG. 08 illustrates the block diagram of the converting device.

FIG. 09 illustrates internal view of a converter that work with coin item.

### DETAILED DESCRIPTION OF THE PREFERRED EMBODIMENTS

The principles and operation of the system according to the present invention may be better understood with reference to the figures and the accompanying description.

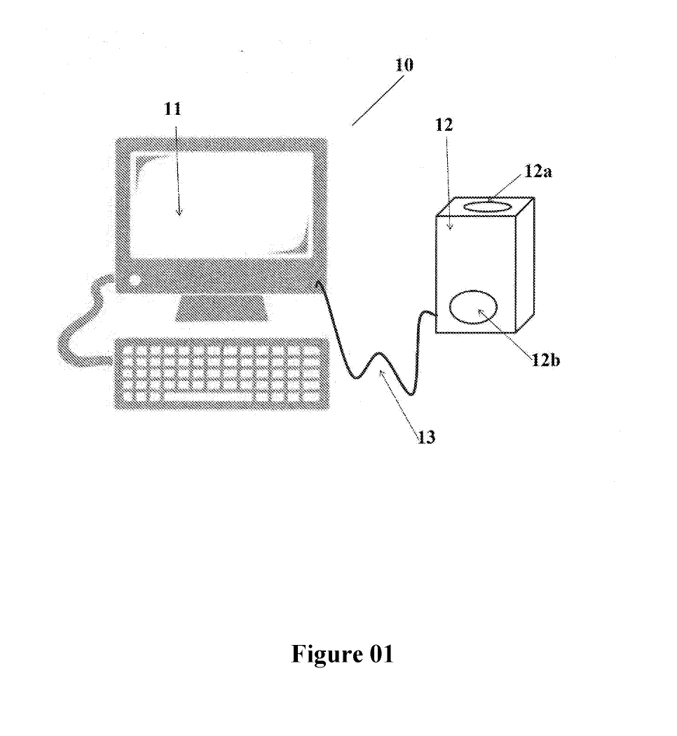

FIG. 01 illustrates the system overview. The system 10 is comprised of computing system 11 with a display (PC, tablet, game console etc.) and a converting device 12 that is connected to the computing system 11 by a connecting cable or wireless 13. The computing system runs a software (usually a game) while the image on the display virtual items can be, appear or disappear. The converting device 12 has an inlet 12a enables to insert items and an outlet 12b from which items can be received.

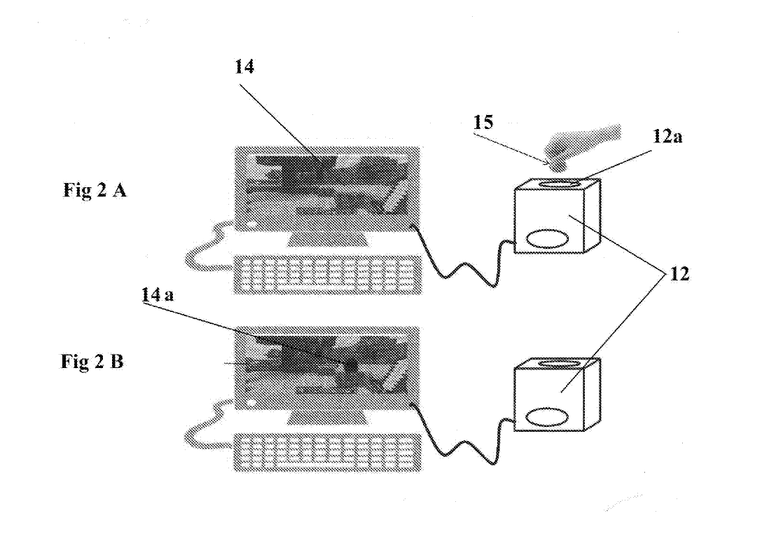

FIG. 02 illustrates the virtualization flow. This figure illustrates the way of exchanging a real item to a virtual item on a display. Part A of the figure shows the situation before inserting any item. The display 14 is displaying an image of a game to which a real item 15 will insert to the inlet 12a of the converter 12 in order to exchange it to a virtual item 14a that will appear on the display 14. Part B of the figure shows the new situation after the real item 15 was inserted to the converter 12. The real item was disappeared and a virtual item 14a is appearing as a part of the displayed image.

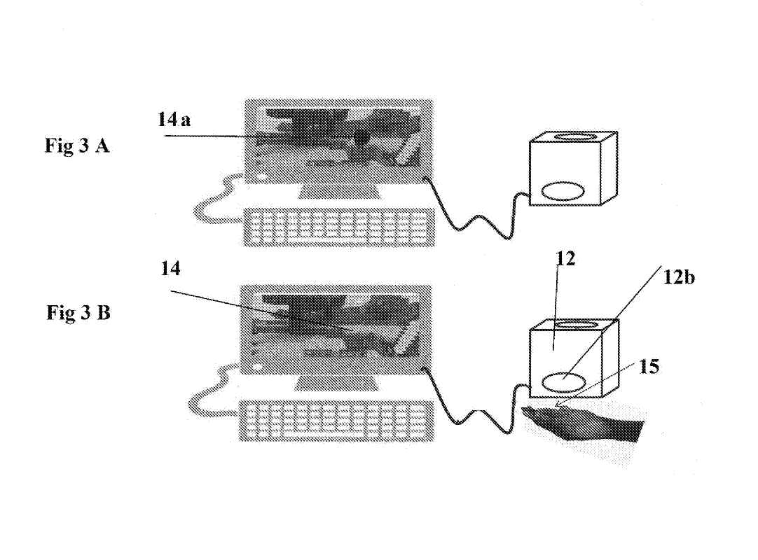

FIG. 03 illustrates the realization flow. This figure illustrates the way of exchanging a virtual item from a display to a real item. In part A of the figure, a virtual item 14a is appearing in the displayed image. While the software or the user decided to exchange this virtual item 14a to a real item, a dedicated command is sent and in part B of the figure the virtual item was disappear from the display 14 and a real item 15 is provided by the converter 12 via its outlet 12b.

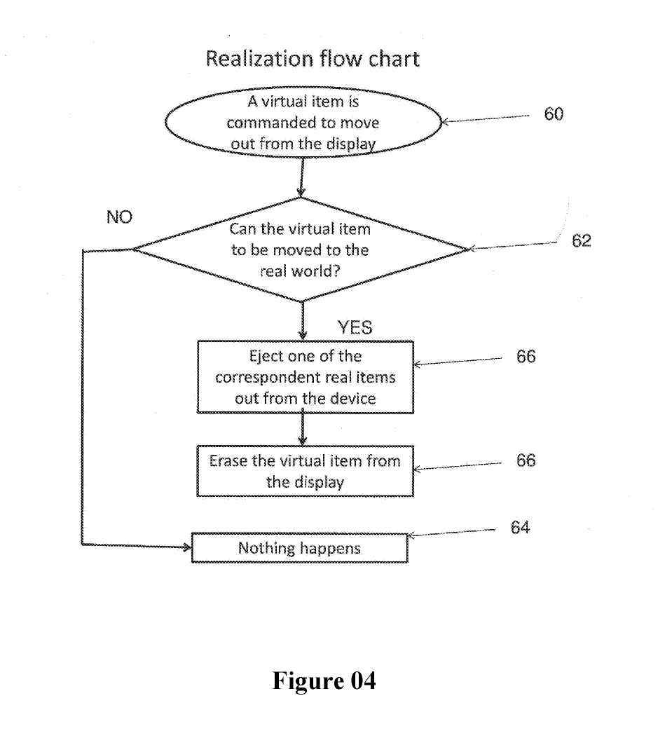

FIG. 04 illustrates realization flow chart. 60—A virtual item is commanded to move out from the display. In the beginning of the virtualization flow there is a virtual item drown on the display. The user or the software notes that it should be realized. The appropriate command is sent to the converter. Another option is: there is a stock of virtual converters, there is a counter that counts the virtual items in the virtual stack. Another option is: the counter counts a summarized value of the items, and not the amount of the items. 62—The converter checks whether the realization is possible i.e., whether there is a corresponding prefab item inside the converter, in case the converter uses prefab items. Or is appropriate real items' stack connected to the converter? Or: whether there are enough raw materials to create the corresponding real item, in case the converter should create a new one. Another question can be: whether it's possible to realize the item from the software view? Is it allowed by game's rules? Does the user have this option enabled? etc. 64—If the item cannot be realized—nothing happens. 66—Eject one of the correspondent real items out from the converter. If the realization is possible—eject one of the corresponding real items out from the converter. If the real items have personal IDs and they are marked as “active” and “inactive”, the ejected item will be marked as “active” in this stage. 68—The original virtual item will be erased from the display. If there is an option to save virtual items in a virtual stack and there is a counter of the virtual stack, the counter will be decreased by the value of the realized items.

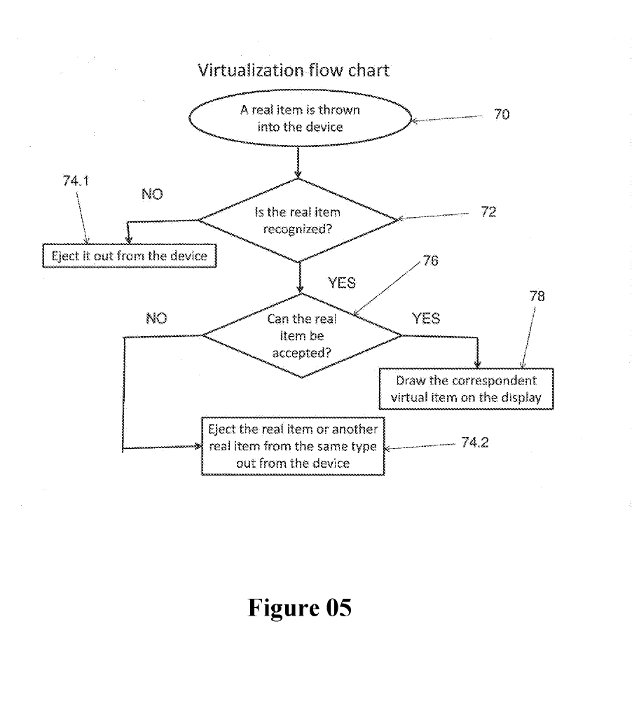

FIG. 05 illustrates virtualization flow chart. 70—A real item is thrown into the converter. In the beginning of the virtualization flow, a real item is inserted to the inlet of the converter. 72—Is the real item recognized? The real item should be recognized by the converter. If the user will insert something not related to the game—it will not be recognized. 74.1—If the item is not recognized, it will be returned outside. 76—If the item is recognized, the converter checks whether it can be acceptable. Is it possible from software's flow? In a case the converter use active-inactive marks, is it “inactive”? Is there enough space to save it, in case it should be saved? Or can it be destroys, in case it should be destroyed? etc. 74.2—If the real item was recognized, but can't be accepted, it should be returned to the user. But also another real item of the same type can be returned. In this case, if the converter works with active and inactive items, the converter should mark the items again to mention their new position. 78—Draw the corresponding virtual item on the display. If all checks were successful, the item can be virtualized. This means that the corresponding virtual item is drawn on the display. The real item can be saved inside the converter, or inside the corresponding real stack, or can be destroyed according the converter's programming/capabilities. But it is not ejected. In case virtual items are saved in a virtual stack with a counter—the counter is increased by the value of the virtualized items.

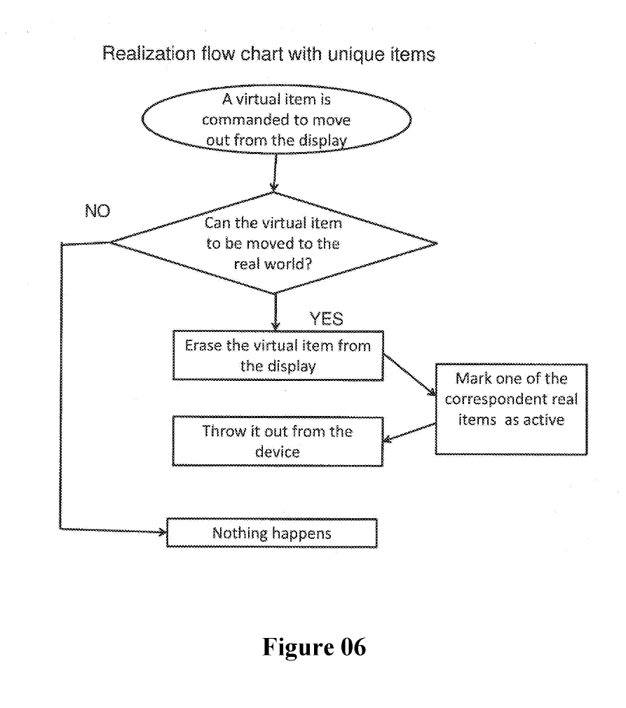

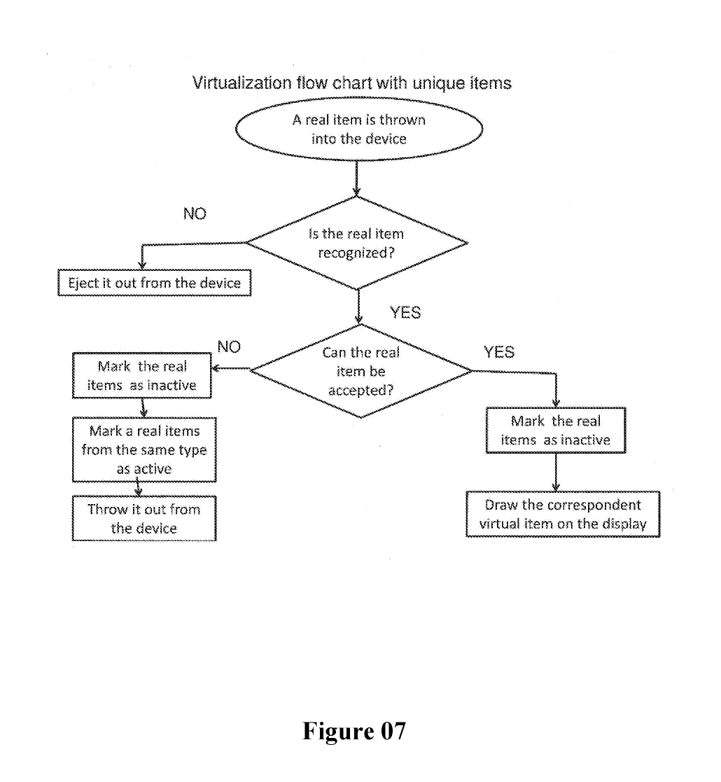

FIG. 06 illustrates realization flow chart with unique items and FIG. 07 illustrates virtualization flow chart with unique items.

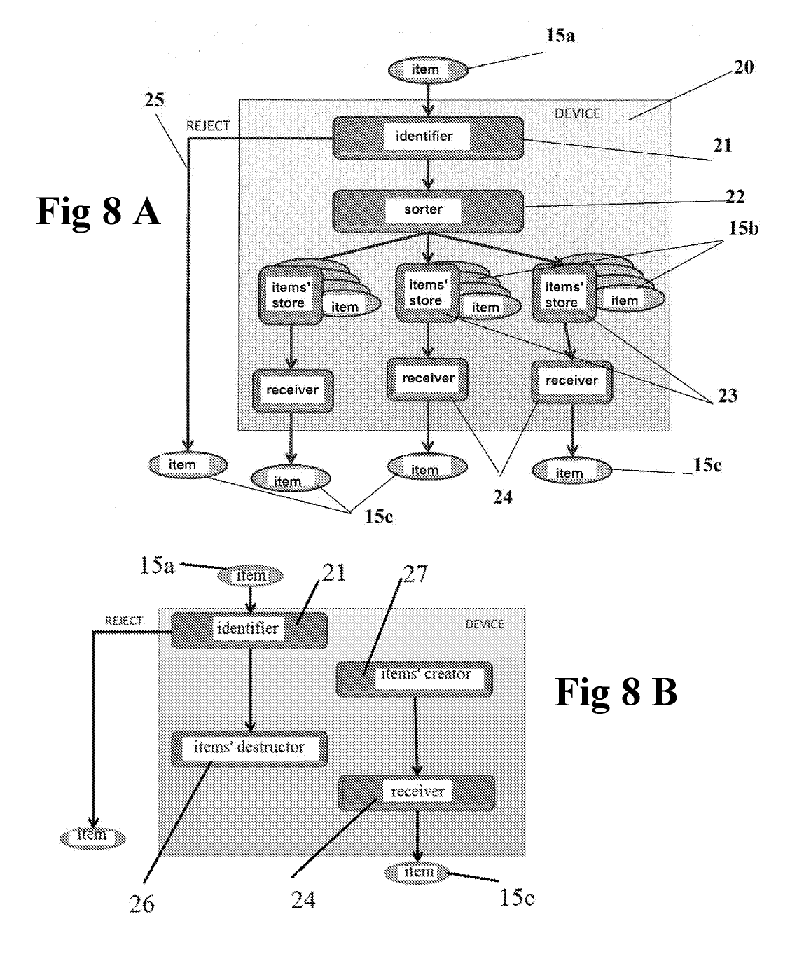

FIG. 08 illustrates two options of the block diagram of the converting device. In part A The converting device can has one items store and one receiver, but this figure illustrates the case wherein the converting device has more than one items store and more than one receiver. A real item 15a can be inserted to the converting device 20, the identifier 21 identified the item. If the item cannot be identified or not acceptable from any other reason, it rejected out 25. The sorter 22 sorts the identified item, according to predetermined criteria, into one of the item's store 23 and the concerning information is reported. While the device 20 is commanded to provide an item from the stored items 15b, the requested item 15c is provided by one of the receivers 24. Part B illustrates a converter 12 that includes a destructor 26 to destruct the real item 15a, which is changed to be virtual and while a virtual item is changed to be real, a creator 27 creates a real item 15c and provide it via the receiver 24.

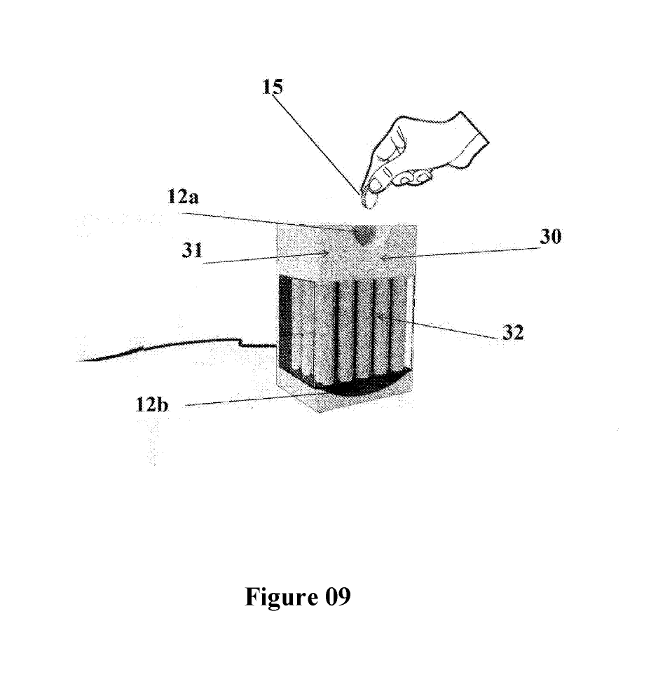

FIG. 09 illustrates internal view of a converter that work with coin item. This is an example for the simplest embodiment. The item that this converter 30 works with—are coins or tokens. The coins 15 can be inserted into the inlet 12a, than they are sorted and sent into appropriate tube 32. When a coin should be ejected (realized), a coin from the appropriate tube is ejected and fails into the outlet 12b. Coins can be of different types, but there is no difference between coins of the same type. The coins can have unique ID, but coins of one type are still interchangeable. After insertion, the coin will be recognized, sorted and stored in an appropriate tube 32. When the coin is ejected, it falls out into the outlet 12b or just be thrown out from the outlet 12b. The tubes 32 can be replaceable. A user can change tubes 32 with coins of one game, by tubes with coins of another game, and the user can play different games with different coins using the same converter and same drivers. There is sorting mechanism 31 inside the converter. The coins are sorted and stored in appropriate tubes 32. If the item is not recognized, it will be thrown out directly, bypassing the tubes.

According to another aspect of the present invention, a plurality of systems that are connected together, of the present invention, can be used each by a different user in a different location, wherein all the users are playing together in the same game. For example, few users are playing together a card game, the card on the table (and the table itself) are virtual and the card that are belong to each player are real. On its turn, the player receive a real card from a virtual pack—from its converter—and return a card or places cards on the virtual table using its converter.

1. A system for converting items from virtual environment to real environment and vice versa, said system is comprised of:
a. A converting device having an inlet, an outlet, an identifying capability and a communication capability, wherein while inserting an identified-able item—through said inlet—said device identified said item and use said communication capability to affect a computing system to add an image of said item to a running software's image, and wherein said device capable to provide an item through said outlet according to said computing system command, same of the item that an image of it was removed from said running software's image; and
b. A computing system with display—running a software—wherein said software capable to add to said software's image—virtual same item of said inserted real item according to said device's command or to delete a virtual item from running software's image and to affect said device to provide same real item through said outlet.

2. The system of claim 1, wherein said converting device is comprised of:
a. An inlet enables to inset item to said converter;
b. An identifier for identifying, said inserted item, and to receive back unidentified items;
c. An item's store capable to store said inserted items, wherein said items are sorted according to a predetermined criteria;
d. A receiver capable to receive items from said store, according to a command; and
e. An outlet enables said received items to get out.

3. The system of claim 2, wherein said item's store is located outside of said converting device.

4. The system of claim 2, further includes a sorter and at least two item's stores and wherein said sorter sorts said inserted items to one of said item's stores according to predetermined criteria.

5. The system of claim 3, further includes at least two receivers, a receiver for each item's store, enables to receive items each item's store through a dedicated receiver.

6. The system of claim 1, wherein said converting device is comprised of:
a. An inlet enables to inset item to said converter;
b. identifier for identifying, said inserted item, and to receive back unidentified items;
c. A item's destructor for destructing said inserted items;
d. An item's creator for creating item according to a command;
e. A receiver capable to receive out said created items; and
f. An outlet enables said received items to get out.

7. The system of claim 1, wherein said item is identified by his shape, by digital ID or any other identification method.

8. The system of claim 1, wherein said items are coins and said converter can be or includes a coin dispenser.

9. The system of claim 1, wherein said converter includes a 3D printer and shredder.

10. The system of claim 1, wherein said converter includes a managing software, wherein said software can includes games or may connect to third party game, wherein said real item is inserted into said device, identified by said device, and said device notifies said game that a new item was added and wherein said inserted item can be moved to the virtual or ejected back to the real and when the real item disappears, it can be destroyed by the device or saved inside thereof.

11. The system of claim 1, wherein said item is made of a plurality of units—e.g., coins—and said system can count or evaluate said units and use said item regarding the number or value of said units.

12. A method for exchanging items from virtual environment to real environment and vice versa, said method comprised of the following steps:
a. using a converting device with identification and communication ability and the ability to get inside identified-able items and get out identified-able items;
b. connecting said device to a computing system that capable to display a software image—usually a game software;
c. while an item is inserted to said device, it is identified and a virtual image of said item is added to said displayed image;
d. if said item cannot be identified, said device gives said item back;
e. while said software removes a virtual item from said display, said software commands said device to get out a real item same of said removed item; and
f. if said device cannot recognize said command, a notice appears on said image.

13. The method of claim 12 wherein said used converting device performs the following steps:
a. receiving an inserted item;
b. identifying, said inserted item, and receiving back unidentified items;
c. sorting and storing said inserted items in an item's store or stores, wherein said items are sorted according to a predetermined criteria;
d. A receiver capable to receive items from said store, according to a command; and
e. Providing an item, a created item or from said item's store, according to command.
